(19) United States
(12) Patent Application Publication
(10) Pub. No.: US 2022/0135431 A1
(43) Pub. Date: May 5, 2022

(54) VEHICULAR WATER-DISPENSING SYSTEM

(71) Applicant: AQUAPHANT, INC., LAS VEGAS, NV (US)

(72) Inventor: THOMAS MULLENAUX, SAN PEDRO, CA (US)

(21) Appl. No.: 16/695,416

(22) Filed: Nov. 26, 2019

Related U.S. Application Data
(63) Continuation-in-part of application No. 16/149,322, filed on Oct. 2, 2018, now Pat. No. 10,513,213.

(51) Int. Cl. C02F 1/00; B60N 3/18; B01D 53/26; B01D 24/10; B01D 24/40; E03B 3/28

(52) U.S. Cl. CPC C02F 1/001; B60N 3/18; B01D 53/265; B01D 24/10; C02F 2209/42; C02F 1/008; E03B 3/28; C02F 2201/005; C02F 2209/40; B01D 24/40

(57) ABSTRACT

The vehicular water-dispensing system claims the benefit of a prior disclosure identified as the non-provisional application U.S. Ser. No. 16/149322. The vehicular water-dispensing system is an enhancement to the prior disclosure. The vehicular water-dispensing system captures condensate from the atmosphere, processes the condensate water into drinking water and transports the drinking water into a water storage reservoir of the prior disclosure. The vehicular water-dispensing system comprises a water generation system, a condensate pump, a condensate filter, and a power circuit. The power circuit is an independently powered system that can operate independently from the vehicle electric system. The water generation system, the condensate pump, and the condensate filter are fluidically connected. The condensate filter fluidically connects to the water storage reservoir of the prior disclosure. The condensate pump electrically connects to the power circuit.

### CROSS REFERENCES TO RELATED APPLICATIONS

This non-provisional application is a continuation-in-part application filed under 37 CFR 1.53(b) that claims the benefit of United States 35 USC 120 from non-provisional application U.S. Ser. No. 16/149322 filed on Oct. 2, 2018 by the inventor: Thomas Mullenaux. This non-provisional application incorporates non-provisional application U.S. Ser. No. 16/149322 in its entirety. The non-provisional application U.S. Ser. No. 16/149322 is itself a continuation-in-part application filed under 37 CFR 1.53(b) that claimed the benefit of United States 35 USC 120 from non-provisional application U.S. Ser. No. 16/140643 also filed by the inventor: Thomas Mullenaux.

### STATEMENT REGARDING FEDERALLY SPONSORED RESEARCH

Not Applicable

### REFERENCE TO APPENDIX

Not Applicable

### BACKGROUND OF THE INVENTION

### FIELD OF THE INVENTION

The present invention relates to the field of passenger vehicles and water dispensers, more specifically, vehicular water-dispensing system.

This non-provisional application is a continuation-in-part application filed under 37 CFR 1.53(b) that claims the benefit of United States 35 USC 120 from non-provisional application U.S. Ser. No. 16/149322 filed on Oct. 2, 2018 by the inventor: Thomas Mullenaux. This non-provisional application incorporates non-provisional application U.S. Ser. No. 16/149322 in its entirety. The non-provisional application U.S. Ser. No. 16/149322 is itself a continuation-in-part application filed under 37 CFR 1.53(b) that claimed the benefit of United States 35 USC 120 from non-provisional application U.S. Ser. No. 16/140643 also filed by the inventor: Thomas Mullenaux.

The present disclosure will only reference the elements of the non-provisional application U.S. Ser. No. 16/149322 that are relevant to the innovations disclosed within this application. This is done for purposes of simplicity and clarity of exposition. The applicant notes that this disclosure incorporates non-provisional application U.S. Ser. No. 16/149322 in its entirety into this application. The fact that any specific innovation selected from the one or more innovations disclosed within U.S. Ser. No. 16/149322 is not addressed in this application should not be interpreted as an indication of defect in the above referenced patent.

Within this disclosure, the non-provisional application U.S. Ser. No. 16/149322 will also be referred to as the prior disclosure.

A summary of the disclosures contained within the prior disclosure that are relevant to the present disclosure is provided below. This summary is provided for clarity and convenience and is not intended to fully represent or reflect the disclosures contained within the prior disclosure. If a discrepancy occurs between this summary and the prior disclosure, the prior disclosure should be considered correct and this summary should be considered in error.

The prior disclosure 400 discloses a water dispensing system. The water dispensing system is configured for use with a vehicle 900. The prior disclosure 400 is adapted to dispense drinking water 106 to the occupants of the vehicle 900. The water dispensing system of the prior disclosure 400 is fully contained within the vehicle 900. The water dispensing system of the prior disclosure 400 is powered by the electric system within the vehicle 900. The prior disclosure 400 comprises a water storage reservoir 430 (referred to in the prior disclosure 400 as the water reservoir 430), a distribution filter 440 (referred to in the prior disclosure 400 as the filter 440), a distribution pump 450 (referred to in the prior disclosure 400 as the pump 450), a distribution valve 460 (referred to in the prior disclosure 400 as the valve 460)—a first retractable hose 420, a second retractable hose 425, a first mouthpiece 410, and a second mouthpiece 415.

The water storage reservoir 430 is a container used to store drinking water 106 for distribution to occupants of the vehicle 900. The drinking water 106 stored in the water storage reservoir 430 is refillable. The distribution pump 450 is a mechanical device that generates a pressure differential which is used for transporting the drinking water 106 from the water distribution reservoir 430 and through the distribution filter 440 to the distribution valve 460. The distribution valve 460 controls the flow of the drinking water 106 into the first retractable hose 420 and the second retractable hose 425.

The first retractable hose 420 transports the drinking water 106 from the distribution valve 460 to the first mouthpiece 410. The second retractable hose 425 transports the drinking water 106 from the distribution valve 460 to the second mouthpiece 415. The first mouthpiece 420 is a mechanical port that allows an individual to draw drinking water 106 from the water dispensing system for consumption. The second mouthpiece 425 is a mechanical port that allows an individual to draw drinking water 106 from the water dispensing system for consumption.

The present disclosure will only reference the elements of the non-provisional application U.S. Ser. No. 16/149322 that are relevant to the innovations disclosed within this application. This is done for purposes of simplicity and clarity of exposition. The applicant notes that this disclosure incorporates non-provisional application U.S. Ser. No. 16/149322 in its entirety into this application. The fact that any specific innovation selected from the one or more innovations disclosed within U.S. Ser. No. 16/149322 is not addressed in this application should not be interpreted as an indication of defect in the above referenced patent.

Within this disclosure, the non-provisional application U.S. Ser. No. 16/149322 will also be referred to as the prior disclosure.

The vehicular water-dispensing system is an enhancement to the prior disclosure described in the Background section of this disclosure. The vehicular water-dispensing system captures condensate water from the atmosphere, processes the condensate water into drinking water and transports the drinking water into the water storage reservoir of the prior disclosure. The vehicular water-dispensing system comprises a water generation system, a condensate pump, and a condensate filter. The power circuit is an independently powered system that can operate independently from the vehicle electric system. The water generation system, the condensate pump, and the condensate filter are fluidically connected. The condensate filter fluidically connects to the water storage reservoir of the prior disclosure. The condensate pump electrically connects to the vehicle electric system.

### SUMMARY OF INVENTION

This non-provisional application is a continuation-in-part application filed under 37 CFR 1.53(b) that claims the benefit of United States 35 USC 120 from non-provisional application U.S. Ser. No. 16/149322 filed on Oct. 2, 2018 by the inventor: Thomas Mullenaux. This non-provisional application incorporates non-provisional application U.S. Ser. No. 16/149322 in its entirety. The non-provisional application U.S. Ser. No. 16/149322 is itself a continuation-in-part application filed under 37 CFR 1.53(b) that claimed the benefit of United States 35 USC 120 from non-provisional application U.S. Ser. No. 16/140643 also filed by the inventor: Thomas Mullenaux.

The present disclosure will only reference the elements of the non-provisional application U.S. Ser. No. 16/149322 that are relevant to the innovations disclosed within this application. This is done for purposes of simplicity and clarity of exposition. The applicant notes that this disclosure incorporates non-provisional application U.S. Ser. No. 16/149322 in its entirety into this application. The fact that any specific innovation selected from the one or more innovations disclosed within U.S. Ser. No. 16/149322 is not addressed in this application should not be interpreted as an indication of defect in the above referenced patent.

Within this disclosure, the non-provisional application U.S. Ser. No. 16/149322 will also be referred to as the prior disclosure.

The vehicular water-dispensing system is an enhancement to the prior disclosure described in the Background section of this disclosure. The vehicular water-dispensing system captures condensate water from the atmosphere, processes the condensate water into drinking water and transports the drinking water into the water storage reservoir of the prior disclosure. The vehicular water-dispensing system comprises a water generation system, a condensate pump, a condensate filter, and a power circuit. The power circuit is an independently powered system that can operate independently from the vehicle electric system. The water generation system, the condensate pump, and the condensate filter are fluidically connected. The condensate filter fluidically connects to the water storage reservoir of the prior disclosure. The condensate pump electrically connects to the vehicle electric system.

These together with additional objects, features and advantages of the vehicular water-dispensing system will be readily apparent to those of ordinary skill in the art upon reading the following detailed description of the presently preferred, but nonetheless illustrative, embodiments when taken in conjunction with the accompanying drawings.

In this respect, before explaining the current embodiments of the vehicular water-dispensing system in detail, it is to be understood that the vehicle water-dispensing system is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the vehicular water-dispensing system.

It is therefore important that the claims be regarded as including such equivalent construction insofar as they do not depart from the spirit and scope of the vehicular water-dispensing system. It is also to be understood that the phraseology and terminology employed herein are for purposes of description and should not be regarded as limiting.

### BRIEF DESCRIPTION OF DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

FIG. 1 is a side view of an embodiment of the disclosure.

FIG. 2 is a top view of an embodiment of the disclosure.

FIG. 3 is a front view of an embodiment of the disclosure.

FIG. 4 is a detail view of an embodiment of the disclosure.

FIG. 5 is a detail view of an embodiment of the disclosure.

FIG. 6 is a schematic view of an embodiment of the disclosure.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

This non-provisional application is a continuation-in-part application filed under 37 CFR 1.53(b) that claims the benefit of United States 35 USC 120 from non-provisional application U.S. Ser. No. 16/149322 filed on Oct. 2, 2018 by the inventor: Thomas Mullenaux. This non-provisional application incorporates non-provisional application U.S. Ser. No. 16/149322 in its entirety. The non-provisional application U.S. Ser. No. 16/149322 is itself a continuation-in-part application filed under 37 CFR 1.53(b) that claimed the benefit of United States 35 USC 120 from non-provisional application U.S. Ser. No. 16/140643 also filed by the inventor: Thomas Mullenaux.

The present disclosure will only reference the elements of the non-provisional application U.S. Ser. No. 16/149322 that are relevant to the innovations disclosed within this application. This is done for purposes of simplicity and clarity of exposition. The applicant notes that this disclosure incorporates non-provisional application U.S. Ser. No. 16/149322 in its entirety into this application. The fact that any specific innovation selected from the one or more innovations disclosed within U.S. Ser. No. 16/149322 is not addressed in this application should not be interpreted as an indication of defect in the above referenced patent.

Within this disclosure, the non-provisional application U.S. Ser. No. 16/149322 will also be referred to as the prior disclosure.

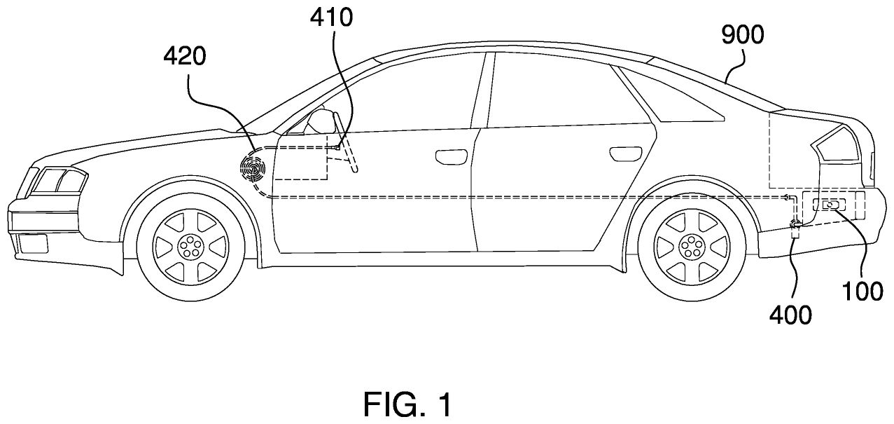

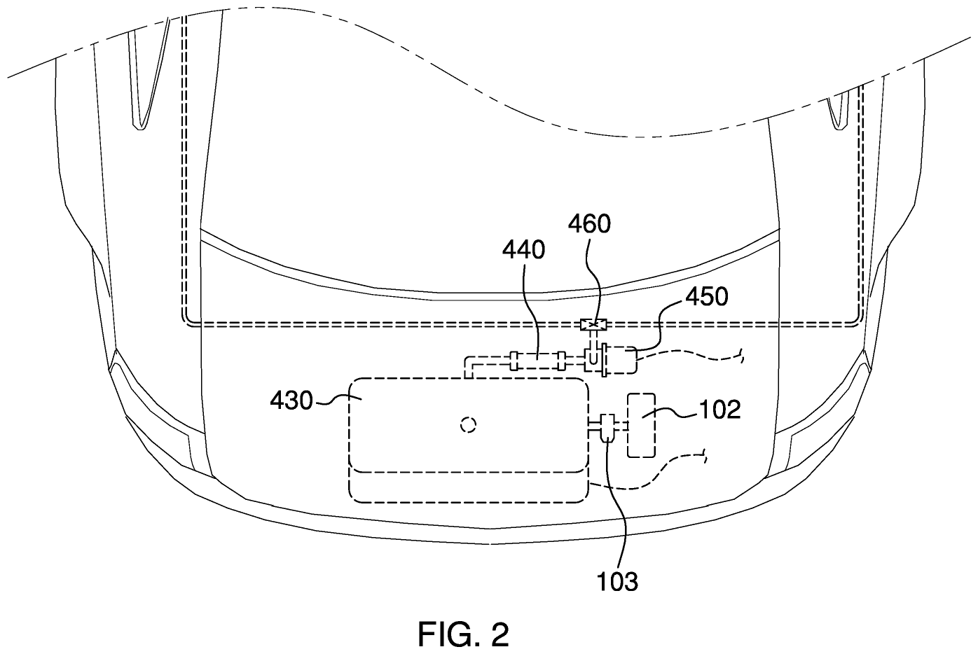

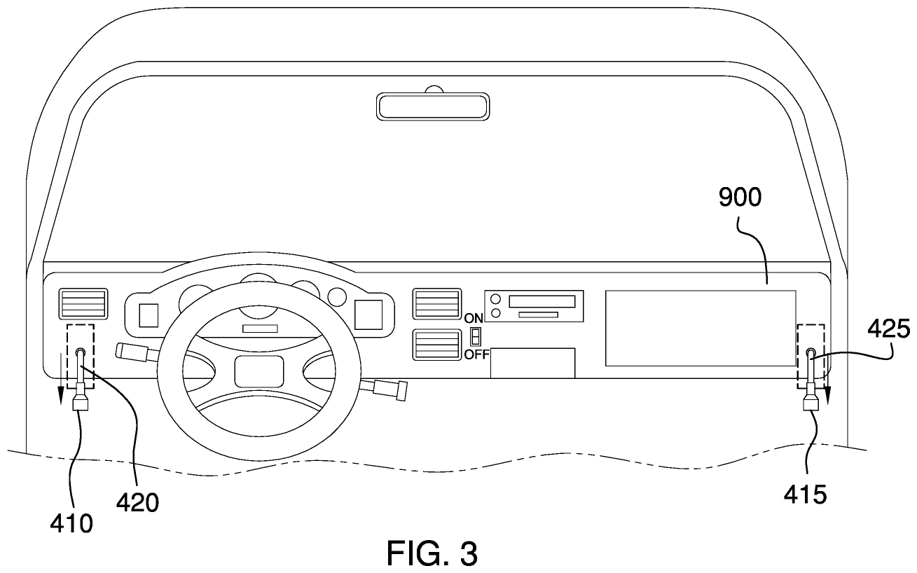

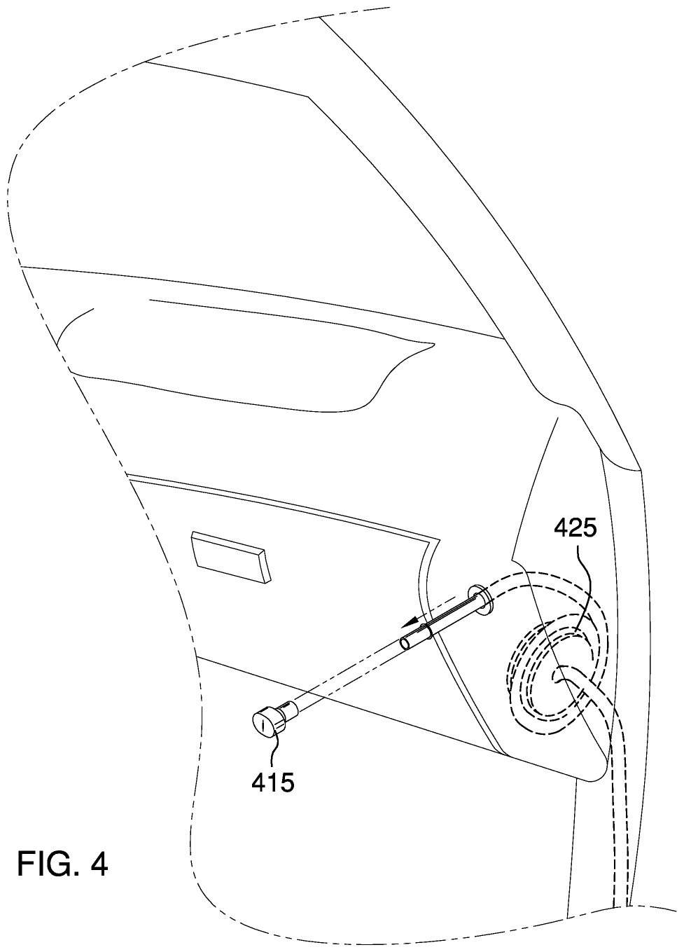

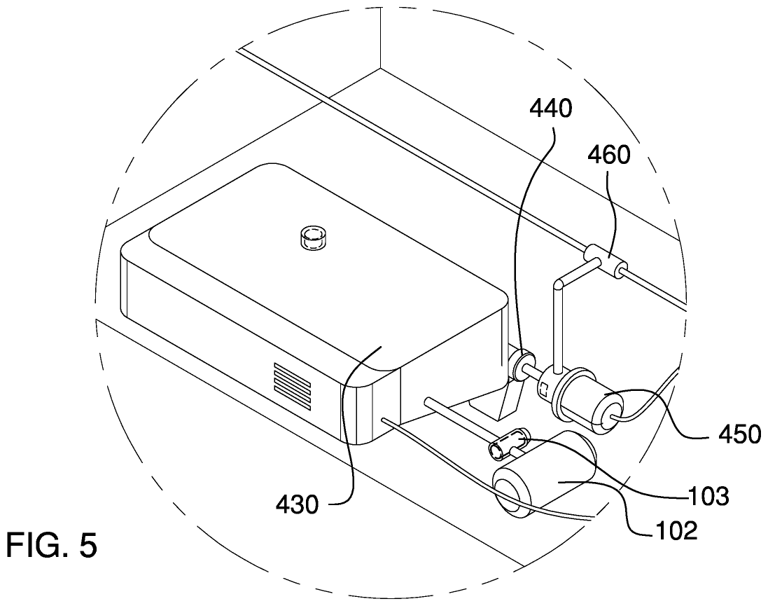

Detailed reference will now be made to one or more potential embodiments of the disclosure, which are illustrated in FIGS. 1 through 5.

The vehicular water-dispensing system 100 (hereinafter invention) is configured for use with the prior disclosure 400 described in the Background section of this disclosure. The prior disclosure 400 comprises a water storage reservoir 430 and a vehicle 900. The invention 100 creates and captures condensate water 105 through a phase change technology, processes the condensate water 105 into drinking water 106 and transports the drinking water 106 into the water storage reservoir 430 of the prior disclosure 400.

The prior disclosure 400 is described in detail in the background section of this disclosure. The water storage reservoir 430 is described in detail in the background section of this disclosure. The vehicle 900 is defined elsewhere in this disclosure. The vehicle 900 further comprises a vehicle 900 electric system 901. The vehicle 900 electric system 901 is a source of electric energy that is provisioned by the vehicle 900. The use of a vehicle 900 electric system 901 as an external power source is well-known and documented in the transportation arts. The vehicle 900 electric system 901 is further defined with a second positive terminal 142 and a second negative terminal 152.

The invention 100 comprises a water generation system 101, a condensate pump 102, a condensate filter 103, and a power circuit 104. The invention 100 is powered using electrical energy provided by the power circuit 104. The water generation system 101, the condensate pump 102, and the condensate filter 103 are fluidically connected. The condensate filter 103 fluidically connects to the water storage reservoir 430 of the prior disclosure 400. The water generation system 101 and the condensate pump 102 electrically connect to the power circuit 104.

The condensate water 105 is a source of water generated by the water generation system 101. The condensate water 105 is generated through a phase change of water from a gas phase into a liquid phase.

The drinking water 106 is the water distributed by the prior disclosure 400 to the occupants of the vehicle 900. The drinking water 106 is defined elsewhere in this disclosure.

The water generation system 101 further comprises a dehumidifier 121 and a condensate reservoir 110. The dehumidifier 121 and the condensate reservoir 110 are fluidically connected.

The dehumidifier 121 is a device that changes the phase of water vapor in the atmosphere into the liquid phase condensate water 105. The dehumidifier 121 is an electrically operated device that draws electrical energy from the power circuit 104. The use of a dehumidifier 121 is well-known and documented in the mechanical arts.

The condensate reservoir 110 is a containment structure. The condensate reservoir 110 collects condensate water 105 from the dehumidifier 121. The condensate reservoir 110 stores the condensate water 105 until the condensate pump 102 pumps the condensate water 105 through the condensate filter 103 and into the water storage reservoir 430 of the prior disclosure 400. The condensate reservoir 110 further comprises a condensate float switch 111, a condensate intake port 112, and a condensate discharge port 113. The condensate float switch 111, the condensate intake port 112, and the condensate discharge port 113 attach to the condensate reservoir 101.

The condensate float switch 111 is an electric switch. The condensate float switch 111 controls the flow of electricity from the power circuit 104 into the condensate pump 102. The condensate float switch 111 detects the volume of condensate water 105 contained in the condensate reservoir 101. The condensate float switch 111 actuates based on the volume of condensate water 105 contained in the condensate reservoir 101.

The condensate float switch 111 actuates to a closed position once the volume of condensate water 105 contained in the condensate reservoir 101 exceeds a predetermined volume level. The actuation of the condensate float switch 111 to the closed position allows electric energy to flow from the power circuit 104 into the condensate pump 102 thereby initiating the operation of the condensate pump 102. The condensate float switch 111 actuates to an open position once the volume of condensate water 105 contained in the condensate pump 102 falls below the predetermined volume level. The actuation of the condensate float switch 111 to the open position discontinues the flow of electric energy from the power circuit 104 into the condensate pump 102 thereby terminating the operation of the condensate pump 102.

In the first potential embodiment of the disclosure, the condensate float switch 111 is selected from the group consisting of a float switch and an electrolytic switch.

The condensate intake port 112 forms a direct fluidic connection with the dehumidifier 121. The condensate intake port 112 transports the condensate water 105 generated by the dehumidifier 121 directly to the condensate reservoir 110. The condensate intake port 112 forms the port that receives the condensate water 105 into the condensate reservoir 110.

The condensate discharge port 113 is a fluidic connection formed between the condensate reservoir 101 and the condensate pump 102. The condensate pump 102 draws the condensate water 105 out of the condensate reservoir 101 through the condensate discharge port 113 for transport into the fluid input of the condensate filter 103.

The condensate pump 102 is a mechanical device. The condensate pump 102 is an electrically powered device. The condensate pump 102 generates a pressure differential. The pressure differential generated by the condensate pump 102 transports the condensate water 105 from the condensate reservoir 101 and through the condensate filter 103 into the water storage reservoir 430 of the prior disclosure 400. The condensate reservoir 101 controls the operation of the condensate pump 102 by controlling the operation of an electric motor that drives the condensate pump 102. The use of a pump is well-known and documented in the mechanical arts.

The condensate filter 103 is a filtering device. The condensate filter 103 filters the condensate water 105 as it passes through the condensate filter 103. The condensate filter 103 converts the condensate water 105 into the drinking water 106 by removing impurities contained within the condensate filter 103. In the first potential embodiment of the disclosure, the condensate filter 103 is a bed filter that passes the condensate water 105 through a bed formed of activated carbon. The condensate filter 103 further comprises a condensate check valve 114.

The condensate check valve 114 forms a direct fluidic connection between the discharge port of the condensate filter 103 and the water storage reservoir 430 of the prior disclosure. The condensate check valve 114 transports the drinking water 106 from the condensate filter 103 into the water storage reservoir 430. The condensate check valve 114 limits the direction of the flow of the drinking water 106 to the direction from the condensate filter 103 into the water storage reservoir 430.

The power circuit 104 is an electrical circuit. The power circuit 104 powers the operation of the invention 100. The power circuit 104 is an electrochemical device. The power circuit 104 converts chemical potential energy into the electrical energy required to power the invention 100. The power circuit 104 is an independently powered electric circuit. By independently powered is meant that the power circuit 104 can operate without drawing power from vehicle 900 electric system 901. The power circuit 104 comprises a battery 131, a diode 132, and the vehicle 900 electric system 901.

The battery 131 is an electrochemical device. The battery 131 converts chemical potential energy into the electrical energy used to power the invention 100. The battery 131 is a commercially available rechargeable battery 131. The chemical energy stored within the rechargeable battery 131 is renewed and restored through the use of the vehicle 900 electric system 901.

The vehicle 900 electric system 901 reverses the polarity of the rechargeable battery 131 and provides the energy necessary to reverse the chemical processes that the rechargeable battery 131 initially used to generate the electrical energy. This reversal of the chemical process creates a chemical potential energy that will later be used by the rechargeable battery 131 to generate electricity.

The diode 132 is an electrical device that allows current to flow in only one direction. The diode 132 installs between the rechargeable battery 131 and the vehicle 900 electric system 901such that electricity will not flow from the first positive terminal 141 of the rechargeable battery 131 into the second positive terminal 142 of the vehicle 900 electric system 901.

The following definitions were used in this disclosure: Activated Carbon: As used in this disclosure, activated carbon is a form of carbon that is processed in a manner that presents a large surface area for chemical interactions. The surface of activated carbon is used to adsorb chemical contaminants from a fluid flow that is passed through the activated carbon.

Aperture: As used in this disclosure, an aperture is a prism-shaped negative space that is formed completely through a structure or the surface of a structure.

Ball Valve: As used in this disclosure, a ball valve is a type of commercially available check valve.

Battery: As used in this disclosure, a battery is a chemical device consisting of one or more cells, in which chemical energy is converted into electricity and used as a source of power. Batteries are commonly defined with a positive terminal and a negative terminal.

Bed Filter: As used in this disclosure, a bed filter comprises a particulate material through which a fluid is passed such that particulate material captures solids contained within the fluid while allowing the fluid itself to pass through the particulate matter.

Check Valve: As used in this disclosure, a check valve is a valve that permits the flow of fluid in a single direction. Within selected potential embodiments of this disclosure, the check valve is a commercially available product that is selected from the group consisting of a ball valve and a Tesla valve.

Diode: As used in this disclosure, a diode is a two terminal semiconductor device that allows current flow in only one direction. The two terminals are called the anode and the cathode. Electric current is allowed to pass from the anode to the cathode.

Drinking Water: As used in this disclosure, drinking water is water that is deemed safe for drinking or use in cooking by humans. A synonym of drinking water is potable water.

Electric Motor: In this disclosure, an electric motor is a machine that converts electric energy into rotational mechanical energy. An electric motor typically comprises a stator and a rotor. The stator is a stationary hollow cylindrical structure that forms a magnetic field. The rotor is a magnetically active rotating cylindrical structure that is coaxially mounted in the stator. The magnetic interactions between the rotor and the stator physically causes the rotor to rotate within the stator thereby generating rotational mechanical energy. This disclosure assumes that the power source is an externally provided source of DC electrical power. The use of DC power is not critical and AC power can be used by exchanging the DC electric motor with an AC motor that has a reversible starter winding.

Electrolytic Switch: As used in this disclosure, an electrolytic switch refers to a switching arrangement wherein the electrolytic switch completes the circuit through the immersion of the electrolytic switch in a water based solution.

External Power Source: As used in this disclosure, an external power source is a source of the energy that is externally provided to enable the operation of the present disclosure. Examples of external power sources include, but are not limited to, electrical power sources and compressed air sources.

Filter: As used in this disclosure, a filter is a mechanical device that is used to separate solids that are suspended in a liquid or a gas. A strainer is type of filter with what would be considered a coarse mesh measurement.

Float Switch: As used in this disclosure, a float switch is a commercially available switch that is actuated by the level of liquid contained within a contained space. A common use of a float switch is in the operation of a bilge or sump pump. Specifically, when the level of accumulated liquid in a bilge or a sump exceeds a predetermined level, the float switch will actuate into a closed position that completes an electric circuit that provides electrical power to a pump that will remove the liquid from the bilge or sump. When the accumulated liquid falls below the predetermined level the float switch will actuate into an open position discontinuing the operation of the pump.

Flow: As used in this disclosure, a flow refers to the passage of a fluid past a fixed point. This definition considers bulk solid materials as capable of flow.

Fluid: As used in this disclosure, a fluid refers to a state of matter wherein the matter is capable of flow and takes the shape of a container it is placed within. The term fluid commonly refers to a liquid or a gas.

Fluidic Connection: As used in this disclosure, a fluidic connection refers to a tubular structure that transports a fluid from a first object to a second object. Methods to design and use a fluidic connections are well-known and documented in the mechanical, chemical, and plumbing arts.

Gas: As used in this disclosure, a gas refers to a state (phase) of matter that is fluid and that fills the volume of the structure that contains it. Stated differently, the volume of a gas always equals the volume of its container.

Hose: As used in this disclosure, a hose is a flexible hollow prism-shaped device that is used for transporting liquids and gases. When referring to a hose in this disclosure, the terms inner dimension and outer dimension are used as they would be used by those skilled in the plumbing arts.

Liquid: As used in this disclosure, a liquid refers to a state (phase) of matter that is fluid and that maintains, for a given pressure, a fixed volume that is independent of the volume of the container.

Motor: As used in this disclosure, a motor refers to the method of transferring energy from an external power source into rotational mechanical energy.

Phase: As used in this disclosure, phase refers to the state of the form of matter. The common states of matter are solid, liquid, gas, and plasma.

Port: As used in this disclosure, a port is an aperture formed in an object that allows fluid to flow through the boundary of the object.

Pump: As used in this disclosure, a pump is a mechanical device that uses suction or pressure to raise or move fluids, compress fluids, or force a fluid into an inflatable object. Within this disclosure, a compressor refers to a pump that is dedicated to compressing a fluid or placing a fluid under pressure.

Reservoir: As used in this disclosure, a reservoir refers to a container or containment system that is configured to store a liquid.

Surface Filter: As used in this disclosure, a surface filter is a type of filter wherein the fluid is passed through a surface or membrane, such as a screen or paper that allows for the passage of the fluid but blocks the passage of larger particles that may be suspended in the fluid. The construction of a surface filter would allow for the passage of the fluid through several filter surfaces in one filtration unit.

Switch: As used in this disclosure, a switch is an electrical device that starts and stops the flow of electricity through an electric circuit by completing or interrupting an electric circuit. The act of completing or breaking the electrical circuit is called actuation. Completing or interrupting an electric circuit with a switch is often referred to as closing or opening a switch respectively. Completing or interrupting an electric circuit is also often referred to as making or breaking the circuit respectively.

Tesla Valve: As used in this disclosure, a Tesla valve is a type of check valve that requires the use of no moving parts.

Tube: As used in this disclosure, a tube is a hollow prism-shaped device formed with two open ends. The tube is used for transporting liquids and gases. The line that connects the center of the first congruent face of the prism to the center of the second congruent face of the prism is referred to as the center axis of the tube or the centerline of the tube. When two tubes share the same centerline they are said to be aligned. When the centerlines of two tubes are perpendicular to each other, the tubes are said to be perpendicular to each other. In this disclosure, the terms inner dimensions of a tube and outer dimensions of a tube are used as they would be used by those skilled in the plumbing arts.

Valve: As used in this disclosure, a valve is a device that is used to control the flow of a fluid (gas or liquid) through a pipe, tube, or hose.

Vehicle: As used in this disclosure, a vehicle is a device that is used for transporting passengers, goods, or equipment. The term motorized vehicle specifically refers to a vehicle can move under power provided by an electric motor or an internal combustion engine. The term vehicle generically applies to motorized vehicles and vehicles without a motor.

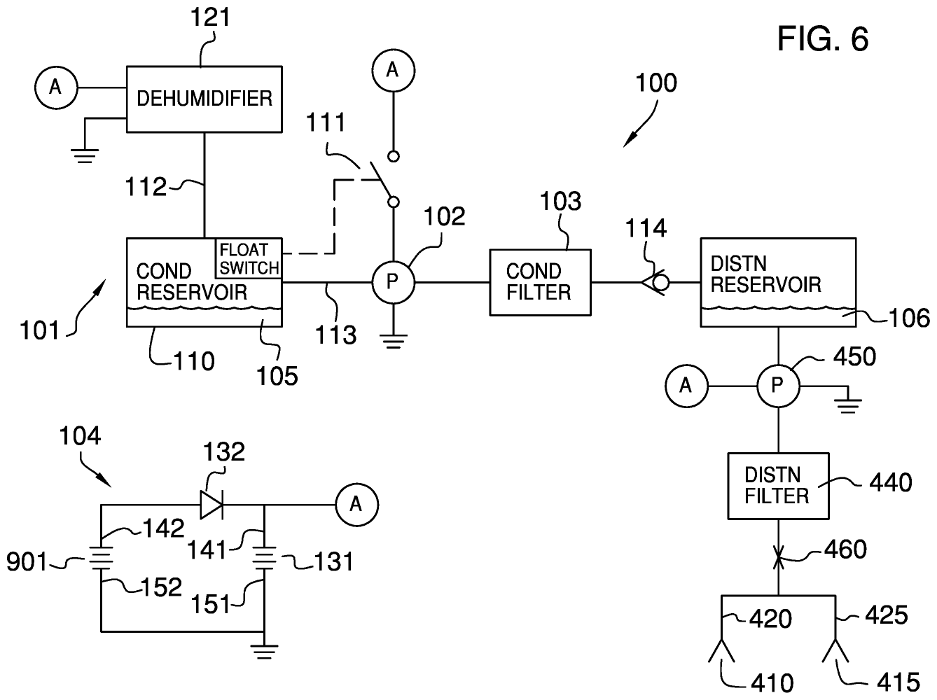

With respect to the above description, it is to be realized that the optimum dimensional relationship for the various components of the invention described above and in FIGS. 1 through 6 include variations in size, materials, shape, form, function, and manner of operation, assembly and use, are deemed readily apparent and obvious to one skilled in the art, and all equivalent relationships to those illustrated in the drawings and described in the specification are intended to be encompassed by the invention.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

What is claimed is:

1. A water filtration system for a vehicle comprising
a water generation system, a condensate pump, a condensate filter, and a power circuit;
wherein the water generation system, the condensate pump, and the condensate filter are fluidically connected;
wherein the water generation system and the condensate pump electrically connect to the power circuit.

2. The water filtration system for a vehicle according to claim 1
wherein the water filtration system for a vehicle is configured for use with a vehicle;
wherein the vehicle further comprises a water storage reservoir;
wherein the vehicle further comprises a vehicle electric system;
wherein the vehicle electric system is further defined with a second positive terminal and a second negative terminal;
wherein the water filtration system for a vehicle creates and captures condensate water from the water generation system;
wherein the water filtration system processes the condensate water into drinking water;
wherein the water filtration system transports the drinking water into the water storage reservoir.

3. The water filtration system for a vehicle according to claim 2 wherein the condensate filter fluidically connects to the water storage reservoir.

4. The water filtration system for a vehicle according to claim 3 wherein the water filtration system is powered by the power circuit.

5. The water filtration system for a vehicle according to claim 4
wherein the water generation system further comprises a dehumidifier and a condensate reservoir;
wherein the dehumidifier and the condensate reservoir are fluidically connected.

6. The water filtration system for a vehicle according to claim 5
wherein the dehumidifier is a device that changes the phase of water vapor in the atmosphere into the liquid phase condensate water;
wherein the dehumidifier is an electrically operated device that draws electrical energy from the power circuit.

7. The water filtration system for a vehicle according to claim 6
wherein the condensate reservoir is a containment structure;
wherein the condensate reservoir collects condensate water from the dehumidifier;
wherein the condensate reservoir stores the condensate.

8. The water filtration system for a vehicle according to claim 7
wherein the condensate pump is a mechanical device;
wherein the condensate pump is an electrically powered device;
wherein the condensate pump generates a pressure differential;
wherein the pressure differential generated by the condensate pump transports the condensate water from the condensate reservoir and through the condensate filter into the water storage reservoir.

9. The water filtration system for a vehicle according to claim 8 wherein the condensate reservoir controls the operation of the condensate pump.

10. The water filtration system for a vehicle according to claim 9
wherein the condensate filter is a filtering device;
wherein the condensate filter filters the condensate water as it passes through the condensate filter;
wherein the condensate filter converts the condensate water into the drinking water.

11. The water filtration system for a vehicle according to claim 10
wherein the condensate reservoir further comprises a condensate float switch, a condensate intake port, and a condensate discharge port;
wherein the condensate float switch, the condensate intake port, and the condensate discharge port attach to the condensate reservoir.

12. The water filtration system for a vehicle according to claim 11
wherein the condensate float switch is an electric switch;
wherein the condensate float switch controls the flow of electricity from the power circuit into the condensate pump.

13. The water filtration system for a vehicle according to claim 12
wherein the condensate float switch detects the volume of condensate water contained in the condensate reservoir;
wherein the condensate float switch actuates based on the volume of condensate water contained in the condensate reservoir.

14. The water filtration system for a vehicle according to claim 13
wherein the condensate float switch actuates to a closed position once the volume of condensate water contained in the condensate reservoir exceeds a predetermined volume level;
wherein the actuation of the condensate float switch to the closed position allows electric energy to flow from the power circuit into the condensate pump thereby initiating the operation of the condensate pump.

15. The water filtration system for a vehicle according to claim 14
wherein the condensate float switch actuates to an open position once the volume of condensate water contained in the condensate pump falls below the predetermined volume level;
wherein the actuation of the condensate float switch to the open position discontinues the flow of electric energy from the power circuit into the condensate pump thereby terminating the operation of the condensate pump.

16. The water filtration system for a vehicle according to claim 15
wherein the condensate intake port forms a direct fluidic connection with the dehumidifier;
wherein the condensate intake port transports the condensate water generated by the dehumidifier directly to the condensate reservoir;
wherein the condensate intake port forms the port that receives the condensate water into the condensate reservoir;
wherein the condensate discharge port is a fluidic connection formed between the condensate reservoir and the condensate pump;
wherein the condensate pump draws the condensate water out of the condensate reservoir through the condensate discharge port for transport into the fluid input of the condensate filter.

17. The water filtration system for a vehicle according to claim 16 wherein the condensate filter is a bed filter.

18. The water filtration system for a vehicle according to claim 17
wherein the condensate filter further comprises a condensate check valve;
wherein the condensate check valve forms a direct fluidic connection between the discharge port of the condensate filter and the water storage reservoir of the prior disclosure;
wherein the condensate check valve transports the drinking water from the condensate filter into the water storage reservoir;
wherein the condensate check valve limits the direction of the flow of the drinking water to the direction from the condensate filter into the water storage reservoir.

19. The water filtration system for a vehicle according to claim 18
wherein the power circuit is an electrical circuit;
wherein the power circuit powers the operation of the water filtration system for a vehicle;
wherein the power circuit is an electrochemical device;
wherein the power circuit is an independently powered electric circuit;
wherein by independently powered is meant that the power circuit can operate without drawing power from vehicle electric system.

20. The water filtration system for a vehicle according to claim 19
wherein the power circuit comprises a battery, a diode, and the vehicle electric system;
wherein the battery is a rechargeable battery;
wherein the vehicle electric system reverses the polarity of the rechargeable battery;
wherein the diode is an electrical device that allows current to flow in only one direction;
wherein the diode installs between the rechargeable battery and the vehicle electric system such that electricity will not flow from the first positive terminal of the rechargeable battery into the second positive terminal of the vehicle electric system.
